(19) United States
(12) Patent Application Publication
(10) Pub. No.: US 2026/0219234 A1
(43) Pub. Date: Jul. 30, 2026

(54) METHOD AND APPARATUS FOR ACOUSTIC PACKAGE HEALTH MONITORING

(71) Applicant: Marvell Asia Pte Ltd, Singapore (SG)

(72) Inventor: Zachary Baldwin, Burlington, VT (US)

(21) Appl. No.: 19/429,062

(22) Filed: Dec. 22, 2025

Related U.S. Application Data
(60) Provisional application No. 63/751,765, filed on Jan. 30, 2025.

(51) Int. Cl. G01N 29/04; G01N 29/24; G01N 29/30

(52) U.S. Cl. CPC G01N 29/04; G01N 29/2437; G01N 29/30; G01N 2291/0231; G01N 2291/101

(57) ABSTRACT

A new approach is proposed that contemplates system and method to support acoustic package health monitoring. A controller is configured to send a set of stimulating electrical signal waveforms to one or more acoustic transducers attached to/embedded in a package that encapsulates an electronic device. Upon receiving the set of stimulating electrical waveforms, each of the one or more acoustic transducers is configured to convert and send a set of acoustic signals through the package, receive a set of acoustic responses from the package, convert and send a set of responsive electrical signal waveforms back to the controller. The controller is configured to monitor and analyze the set of responsive electrical signal waveforms received back from the one or more acoustic transducers and send an alert if a significant deviation in the set of acoustic responses reflecting a physical change in structure of the package is detected.

### RELATED APPLICATION

This application is a nonprovisional application and claims the benefit and priority to a provisional application No. 63/751,765 that was filed on Jan. 30, 2025, which is incorporated herein by reference in its entirety.

### BACKGROUND

Modern computing systems such as artificial intelligence (AI) systems typically operate at an incredible scale, including, e.g., over one hundred thousand computing nodes/elements and executing jobs/applications that may take days or months to complete. During this period of time, hardware degradation and failure may occur at such scale, impacting run time to completion of the jobs. When a single computing node fails, the entire computing system often needs to be restored to the last checkpoint, resulting in a loss of progress. In existing computing systems, failures can occur as often as every three hours. As such, early detection of weak or failing hardware in a computing system is critical for preventive maintenance and reducing wasted computing resources.

Currently, failure monitoring is often limited to on-die monitoring via one or more of temperature sensors, voltage sensors, delay monitors, or ring oscillators associated with the computing nodes in a computing system. If a stuck-at fault or an open fault is detected, die-to-die (D2D) and high speed IO interconnects can be repaired if a spare or redundant lane is available. However, existing approaches are unable to detect issues and failures related to the packages of the computing nodes such as partially cracked package traces or solder joints.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A depicts an example of a diagram of a system to support acoustic package health monitoring according to one aspect of the present embodiments; FIG. 1B depicts an example of signal paths between the controller and the one or more acoustic transducers of FIG. 1A according to one aspect of the present embodiments.

FIG. 2A depicts an example of an acoustic profile for the package according to one aspect of the present embodiments; FIG. 2B depicts an example of an in-bound responsive electrical signal waveform, wherein the deviation from the acoustic profile is within a user-specified threshold according to one aspect of the present embodiments; FIG. 2C depicts an example of an out-of-bound responsive electrical signal waveform having significant deviations from the acoustic profile, indicating a package delamination event has occurred to the package according to one aspect of the present embodiments.

FIG. 3 depicts a flowchart of an example of a process to support acoustic package health monitoring according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A new approach is proposed that contemplates system and method to support acoustic package health monitoring. A controller is configured to send a set of stimulating electrical signal waveforms to one or more acoustic transducers attached to/embedded in a package that encapsulates an electronic device. Upon receiving the set of stimulating electrical waveforms, each of the one or more acoustic transducers is configured to convert and send a set of acoustic signals through the package, receive a set of acoustic responses from the package, convert and send a set of responsive electrical signal waveforms back to the controller. The controller is configured to monitor and analyze the set of responsive electrical signal waveforms received back from the one or more acoustic transducers and send an alert if a significant variation in the set of acoustic responses indicating a physical change in structure of the package is detected.

The proposed approach enables early detection of compromised mechanical structures within a package of an electronic device. Through such early detection, the proposed approach provides early prediction of mechanical-related failures such as those induced by thermal stress so the package can be replaced promptly before full package failure. Additionally, since the proposed approach is highly sensitive to minor changes or variations in acoustic responses/resonances of the package, it can detect physical attacks where the package is directly contacted or modified via, e.g., a probing of IO or die-to-die signals.

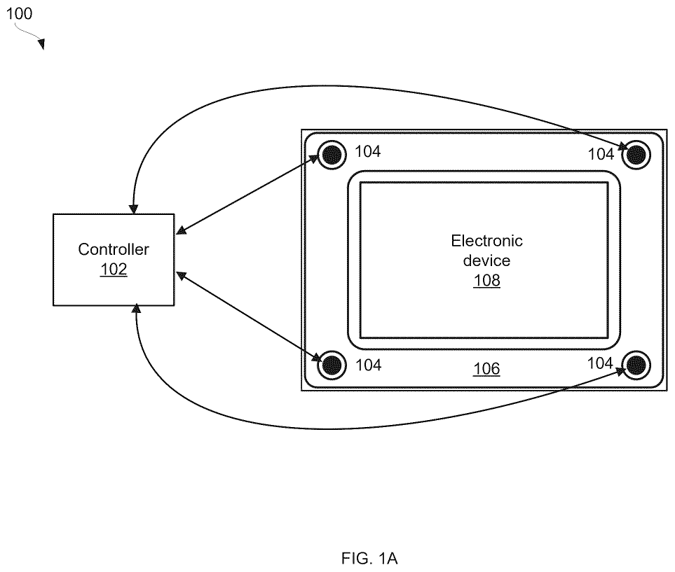

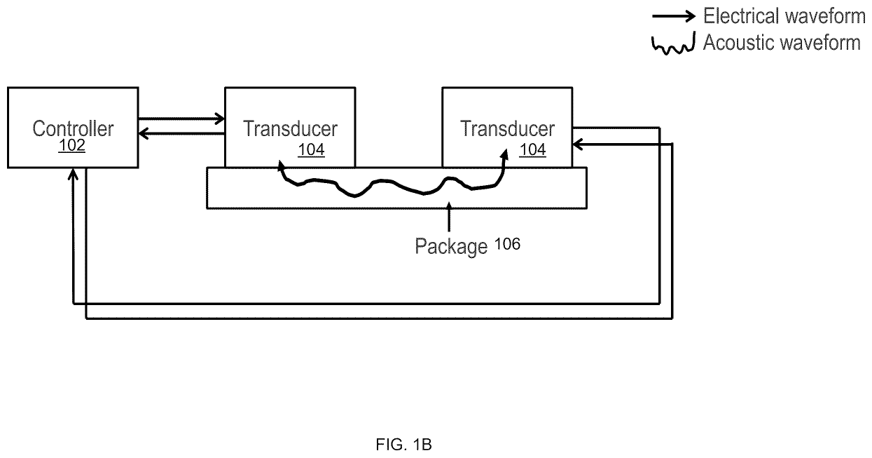

FIG. 1A depicts an example of a diagram of a system 100 to support acoustic package health monitoring. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1A, the system 100 includes a controller 102, and one or more acoustic transducers 104s deployed/attached/embedded/coupled to a package 106 encapsulating an electronic device 108. It is appreciated that the controller 102 can be but is not limited to a computing device, e.g., a microcontroller or microprocessor with software instructions stored in a storage such as a non-volatile memory of the computing device for practicing one or more processes. When the software instructions are executed, at least a subset of the software instructions is loaded into memory by the computing device, which becomes a specially purposed device for practicing the processes. The processes may also be at least partially embodied in the computing device into which computer program code is loaded and/or executed such that the computing device become special purpose computing device for practicing the processes, e.g., interacting with the one or more acoustic transducers 104s. For non-limiting examples, the computing device can be but is not limited to a server machine, a laptop PC, a desktop PC, a tablet, a Google Android device, an iPhone, an iPad, and a voice-controlled speaker or controller.

In the example of FIG. 1A, the package 106 is utilized to encapsulate the electronic device 108 on a silicon substrate in one of metal, plastic, glass, or ceramic casing containing the electronic device 108. In some embodiments, the electronic device 108 encapsulated in the package 106 is a discrete electronic device. In some embodiments, the electronic device 108 is an integrated circuit (IC), which, for a non-limiting example, can be but is not limited to a computing element/node that includes one of a CPU, a DPU, a GPU, a TPU, a XPU, or any other type of processing unit or hardware accelerator configured to execute software instructions stored in a storage unit for practicing one or more processes, jobs, applications, and tasks.

In the example of FIG. 1A, the controller 102 is electrically connected to the one or more acoustic transducers 104s either by wire or wirelessly via a communication network, which can be but is not limited to Bluetooth, Wi-Fi, and other types of mobile communication network. In some embodiments, the controller 102 is placed in the same package 106, e.g., encapsulated in the same casing of the electronic device with the one or more acoustic transducers 104s. In some embodiments, the controller 102 is placed off-package, i.e., outside of and external to the package 106 of the electronic device 108. In some embodiments, the controller 102 is placed on a same circuit/system board with the one or more acoustic transducers 104s.

In some embodiments, each of the one or more acoustic transducers 104s is a piezoelectric device placed on or embedded in the substrate of the package 106 at distributed locations, wherein each piezoelectric device utilizes piezoelectric effect to convert electrical signals to acoustic signals, or vice versa. In some embodiments, a single acoustic transducer 104 may be attached/embedded near each corner of the package 106 as shown by the example of FIG. 1A.

FIG. 1B depicts an example of signal paths between the controller 102 and the one or more acoustic transducers 104s of FIG. 1A. As shown by the example of FIG. 1B, the controller 102 is configured to stimulate the one or more acoustic transducers 104s by sending a set of stimulating electrical signal waveforms to each of the one or more acoustic transducers 104s. In some embodiments, the set of stimulating electrical signal waveforms may include one or more electrical signal schemes such as frequency hopping or single frequency. In some embodiments, each of the set of stimulating electrical signal waveforms may be either intermittent or continuous. Simultaneously, the controller 102 is configured to monitor and analyze a set of responsive electrical signal waveforms received from each of the one or more acoustic transducers 104s as discussed in detail below.

Upon receiving the set of electrical signal waveforms from the controller 102, each of the one or more acoustic transducers 104s is configured to convert the set of electrical signal waveforms to a set of acoustic waveforms and send the set of acoustic signals/waveforms through the package 106. Each of the one or more acoustic transducers 104s is also configured to receive a set of acoustic responses through the package 108, convert the set of acoustic responses to the set of responsive electrical signal waveforms, and send the set of responsive electrical signal waveforms back to the controller 102.

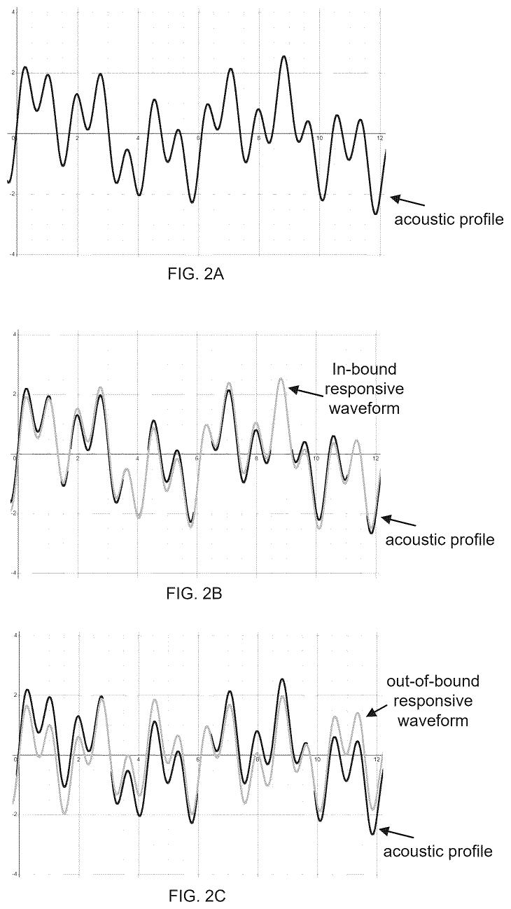

In some embodiments, the controller 102 is configured to send a set/series of test/calibration signal waveforms to the one or more acoustic transducers 104s during a packaging or system initialization/start phase. The controller 102 then monitors and records responses to the calibration signal waveforms from the one or more acoustic transducers 104s. Based on the recorded responses, the controller 102 is configured to create an acoustic profile for the package 106 when it is at a “healthy” state. FIG. 2A depicts an example of an acoustic profile for the package 106. This profile is later used as a reference point to be compared with later responses to detect changes in the package 108 during usage.

In some embodiments, the controller 102 is configured to send a set of electrical signal waveforms to each of the one or more acoustic transducers 104s and to receive a set of responsive electrical signal waveforms from each of the one or more acoustic transducers 104s in return during operation. The controller 102 then analyzes and compares the set of received responsive electrical signal waveforms to the acoustic profile for the package 106 to determine any differences or deviations between the two. In some embodiments, the controller 102 is configured to identify a deviation as significant or not (“in-bound”) according to pre-determined or user-specified threshold. FIG. 2B depicts an example of an in-bound responsive electrical signal waveform, which is in-bound and not significantly different from the acoustic profile, e.g., the deviation from the acoustic profile is within the user-specified threshold and there is no significant physical change to the structure of the package 106. Any significant variations between the two may indicate a physical change in structure of the package 106 and potentially an early stage of mechanical failure of the package 106. Such physical changes in the package 106 can include but are not limited to package delamination or cracking of solder joints. FIG. 2C depicts an example of an out-of-bound responsive electrical signal waveform having significant deviations from the acoustic profile, indicating a package delamination event has occurred to the package 106. In some embodiments, the controller 102 is configured to send an alert to a user (e.g., a host system) of the electronic device 108 (e.g., a compute node) encapsulated in the package 106 or the electronic device 108 itself through a communication channel (e.g., a wireless network) that a failure event of the package 106 will or has occurred if a significant deviation is detected. The user and/or the electronic device 108 may then take pre-cautionary measures, e.g., shutting down the electronic device 108 preemptively so that the package 106 of the electronic device 108 can be replaced.

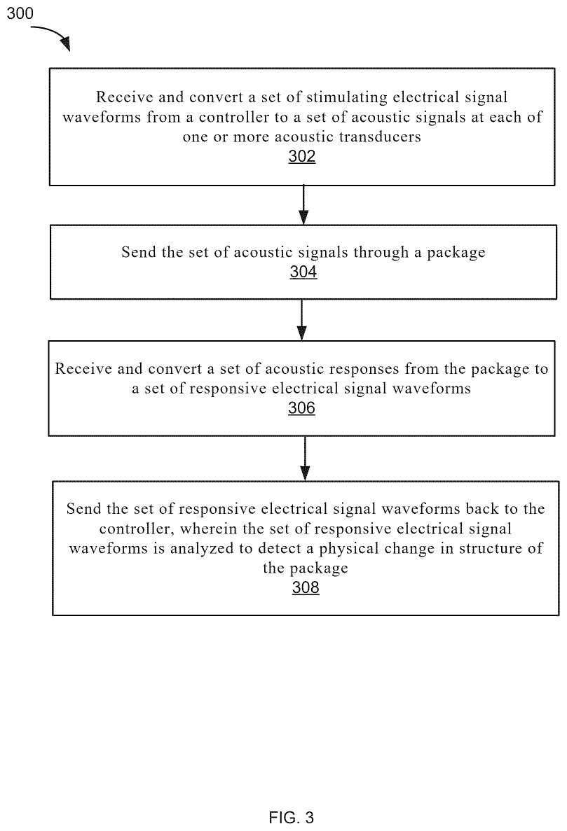

FIG. 3 depicts a flowchart 300 of an example of a process to support acoustic package health monitoring. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where a set of stimulating electrical signal waveforms from a controller is received and converted to a set of acoustic signals at each of one or more acoustic transducers. The flowchart 300 continues to step 304, where the set of acoustic signals is sent through a package. The flowchart 300 continues to step 306, where a set of acoustic responses is received from the package and converted into a set of responsive electrical signal waveforms. The flowchart 300 ends at step 308, where the set of responsive electrical signal waveforms is sent back to the controller, wherein the set of responsive electrical signal waveforms is analyzed to detect a physical change in structure of the package.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
one or more acoustic transducers attached to a package of an electronic device, wherein each of the one or more acoustic transducers is configured to
receive and convert a set of stimulating electrical signal waveforms from a controller to a set of acoustic signals;
send the set of acoustic signals through the package;
receive and convert a set of acoustic responses from the package to a set of responsive electrical signal waveforms; and
send the set of responsive electrical signal waveforms back to the controller, wherein the set of responsive electrical signal waveforms is analyzed to detect a physical change in structure of the package.

2. The system of claim 1, wherein:
the package is utilized to encapsulate the electronic device on a silicon substrate in one of metal, plastic, glass, and ceramic casing.

3. The system of claim 1, wherein:
the electronic device is an integrated circuit (IC).

4. The system of claim 1, wherein:
the electronic device is a processing unit or hardware accelerator configured to execute software instructions stored in a storage unit.

5. The system of claim 1, wherein:
each of the one or more acoustic transducers is a piezoelectric device embedded in the package at distributed locations.

6. The system of claim 5, wherein:
one of the one or more acoustic transducers is embedded near each corner of the package.

7. The system of claim 1, wherein:
the set of stimulating electrical signal waveforms includes one or more of frequency hopping and single frequency.

8. The system of claim 1, wherein:
each of the set of stimulating electrical signal waveforms is either intermittent or continuous.

9. The system of claim 1, further comprising:
said controller configured to
send the set of stimulating electrical signal waveforms to the one or more acoustic transducers; and
monitor and analyze the set of responsive electrical signal waveforms received back from the one or more acoustic transducers to detect a physical change in structure of the package.

10. The system of claim 9, wherein:
the controller is electrically connected to the one or more acoustic transducers either by wire or wirelessly via a communication network.

11. The system of claim 9, wherein:
the controller is placed in a same package as the electronic device with the one or more acoustic transducers.

12. The system of claim 9, wherein:
the controller is placed outside of the package of the electronic device.

13. The system of claim 12, wherein:
the controller is placed on a same circuit board with the one or more acoustic transducers.

14. The system of claim 9, wherein:
the controller is configured to
send a set of calibration signal waveforms to the one or more acoustic transducers during an initialization phase of the package; and
create an acoustic profile for the package based on responses to the set of calibration signal waveforms from the one or more acoustic transducers.

15. The system of claim 14, wherein:
the controller is configured to compare and determine a deviation between the set of received responsive electrical signal waveforms to the acoustic profile.

16. The system of claim 15, wherein:
the controller is configured to detect the physical change in structure of the package if the deviation between the set of received responsive electrical signal waveforms to the acoustic profile exceeds a pre-defined threshold.

17. The system of claim 16, wherein:
the controller is configured to send an alert to a user of the electronic device or the electronic device itself if the physical change in the structure of the package is detected.

18. A method, comprising:
receiving and converting a set of stimulating electrical signal waveforms from a controller to a set of acoustic signals at each of one or more acoustic transducers;
sending the set of acoustic signals through a package;
receiving and converting a set of acoustic responses from the package into a set of responsive electrical signal waveforms; and
sending the set of responsive electrical signal waveforms back to the controller, wherein the set of responsive electrical signal waveforms is analyzed to detect a physical change in structure of the package.

19. The method of claim 18, further comprising:
embedding one of the one or more acoustic transducers near each corner of the package.

20. The method of claim 18, further comprising:
placing the controller in a same package of the electronic device with the one or more acoustic transducers.

21. The method of claim 18, further comprising:
placing the controller outside of the package of the electronic device.

22. The method of claim 21, further comprising:
placing the controller on a same circuit board with the one or more acoustic transducers.

23. The method of claim 18, further comprising:
sending a set of stimulating electrical signal waveforms from a controller to one or more acoustic transducers attached to a package of an electronic device;
monitoring and analyzing the set of responsive electrical signal waveforms received back from the one or more acoustic transducers to detect a physical change in structure of the package.

24. The method of claim 23, further comprising:
sending a set of calibration signal waveforms to the one or more acoustic transducers during an initialization phase of the package; and
creating an acoustic profile for the package based on responses to the set of calibration signal waveforms from the one or more acoustic transducers.

25. The method of claim 24, further comprising:
comparing and determining a deviation between the set of received responsive electrical signal waveforms to the acoustic profile.

26. The method of claim 25, further comprising:
detecting the physical change in structure of the package if the deviation between the set of received responsive electrical signal waveforms to the acoustic profile exceeds a pre-defined threshold.

27. The method of claim 26, further comprising:
sending an alert to a user of the electronic device or the electronic device itself if the physical change in the structure of the package is detected.

28. A system, comprising:
a means for receiving and converting a set of stimulating electrical signal waveforms from a controller to a set of acoustic signals at each of one or more acoustic transducers;
a means for sending the set of acoustic signals through a package;
a means for receiving and converting a set of acoustic responses from the package into a set of responsive electrical signal waveforms; and
a means for sending the set of responsive electrical signal waveforms back to the controller, wherein the set of responsive electrical signal waveforms is analyzed to detect a physical change in structure of the package.
